(19) United States
(12) Patent Application Publication
(10) Pub. No.: US 2024/0399727 A1
(43) Pub. Date: Dec. 5, 2024

(54) RECYCLABLE PACKAGING FILM FOR RETORT APPLICATIONS

(71) Applicant: AMCOR FLEXIBLES NORTH AMERICA, INC., Neenah, WI (US)

(72) Inventors: Ankush GOKHALE, Fulshear, TX (US); James LAMB, Appleton, WI (US)

(21) Appl. No.: 18/696,899

(22) PCT Filed: Oct. 21, 2021
(86) PCT No.: PCT/US2021/055943

§ 371 Date: Mar. 28, 2024

(51) Int. Cl. B32B 27/30; B32B 7/12; B32B 27/08; B32B 27/32; B32B 27/34

(52) U.S. Cl. CPC B32B 27/306; B32B 7/12; B32B 27/08; B32B 27/32; B32B 27/34; B32B 2250/05; B32B 2250/24; B32B 2307/724; B32B 2307/7376; B32B 2323/10; B32B 2439/46; B32B 2439/70

(57) ABSTRACT

A multilayer barrier film includes an outer layer comprising a polyamide polymer, a first inner layer including an ethylene vinyl alcohol (EVOH) copolymer, a second inner layer including a polyolefin polymer, a third inner layer including an EVOH copolymer, a fourth inner layer including a polyamide polymer or a polyolefin polymer, and an outer layer including a sealing layer. Rapid post-retort recovery of oxygen barrier is achieved by these films and retort containers made therefrom.

### TECHNICAL FIELD

This disclosure is related to film structures, specifically film structures appropriate for retort packaging applications. The film structures have a composition suitable for recycling.

### BACKGROUND

Retort operations are used for thermal processing of packaged food and sterilization of the primary packaging components. Food packaged in a retortable container, such as a pouch or a thermoformed container, is transferred to an autoclave unit where it is subjected to retort conditions including temperatures generally exceeding the boiling point of water and elevated pressures for a time period that may extend from minutes to an hour or more. Retortable packaging, therefore, is designed to withstand retort conditions.

Ethylene-vinyl alcohol (“EVOH”) copolymers are well-known for their oxygen gas barrier properties. Effectiveness of an EVOH oxygen barrier is highly dependent on relative humidity. That is, exposure to elevated humidity results in reduced capacity of the EVOH to provide a gas barrier, which can be measured as an oxygen transmission rate (OTR). In coextruded films, in addition to its oxygen barrier properties, EVOH has excellent durability, good thermoforming performance and good appearance (clarity), which are desired features in retortable containers.

Some films designed for retort packaging applications utilize protective high moisture barrier outer layers on an EVOH-containing film. This design helps protect the EVOH from moisture such that low OTR levels are maintained. Even so, an increase in OTR after exposure of EVOH containing retortable containers to retort conditions is expected due to exposure of the container to extreme wet-heat conditions. This increase is temporary and is referred to as retort-shock. The loss in oxygen barrier/increase in OTR is, for the most part, reversible and the oxygen barrier recovers as the material dries out. Some EVOH-containing retortable containers in the state of the art can experience long retort-shock recovery times in that only after a longer period of time (days/weeks) does the oxygen barrier become fully established again.

Although there are other barrier materials such as silicon oxide coatings or aluminum foil which show no retort-shock, these materials either cannot be deep-drawn (e.g. for meal trays/containers) or have other unfavorable properties (i.e. opaque, not as durable against flexing).

Some other retort packaging products may combine materials such as oriented polyethylene terephthalate (OPET), biaxially-oriented nylon (BON), AlOx, foil, and the like with a polypropylene sealant. Such products are made by laminating multiple plies to form, for example, 3-ply and 4-ply structures. Again, these laminations cannot be deep-drawn or have other unfavorable properties. Specifically, films that contain materials such as OPET, BON or metal are more challenging to recycle.

### SUMMARY

There is an on-going need to provide films for packaging that provide combinations of the following properties: good retort-shock recovery, thermoformability, a high barrier to oxygen, optical clarity and recyclability.

Embodiments of the multilayer barrier film include: a first outer layer containing a first polyamide polymer, a first inner layer adjacent to the first outer layer, the first inner layer containing a first ethylene vinyl alcohol (EVOH) copolymer, a second inner layer adjacent to the first inner layer, the second inner layer containing a first polyolefin polymer, a third inner layer adjacent to the second inner layer, the third inner layer containing a second ethylene vinyl alcohol (EVOH) copolymer, a fourth inner layer adjacent to the third inner layer, the fourth inner layer containing a second polyamide polymer or a second polyolefin polymer, and a second outer layer, the second outer layer being a sealing layer. The multilayer barrier film has a total composition including less than or equal to 10%, by weight, EVOH copolymer, and less than or equal to 10%, by weight, polyamide polymer.

Some embodiments of the multilayer barrier film may have a sealing layer that includes a polypropylene copolymer. Additionally, the sealing layer may be part of a cast film or a blown film.

In some embodiments of the multilayer barrier film the total composition of the multilayer barrier film comprises less than or equal to 5%, by weight, EVOH copolymer.

The multilayer barrier film may have a thickness between 3 mil and 20 mil.

Some embodiments of the multilayer barrier film have a total composition including between 70% and 95%, by weight, polyolefin. The multilayer barrier film may have total composition including between 70% and 95%, by weight, polypropylene.

In some embodiments of the multilayer barrier film, the first ethylene vinyl alcohol (EVOH) copolymer is retortable. Likewise, in some embodiments of the multilayer barrier film the second ethylene vinyl alcohol (EVOH) copolymer is retortable.

The first outer layer may have a moisture vapor transmission rate (MVTR) of greater than or equal to 10 gram·mil/100 in²/day. The moisture vapor transmission rate (MVTR) of the first polyamide polymer may be between 10 gram·mil/100 in²/day and 40 gram·mil/100 in²/day.

For some embodiments of the multilayer barrier film, the first outer layer is in direct contact with the first inner layer, the first inner layer is in direct contact with the second inner layer, and the second inner layer is in direct contact with the third inner layer.

The multilayer barrier film is thermoformable.

The multilayer barrier film may also include an adhesive layer located between the fourth inner layer and the second outer layer.

The first polyolefin polymer may be a maleic anhydride grafted polypropylene copolymer.

Disclosed herein are some embodiments of the multilayer barrier film for food packaging including: a first outer layer containing a first polyamide polymer, a first inner layer adjacent to the first outer layer, the first inner layer containing a first ethylene vinyl alcohol (EVOH) copolymer, a second inner layer adjacent to the first inner layer, the second inner layer containing a first polypropylene copolymer, a third inner layer adjacent to the second inner layer, the third inner layer containing a second ethylene vinyl alcohol (EVOH) copolymer, a fourth inner layer adjacent to the third inner layer, the fourth inner layer containing a second polyamide polymer, an adhesive layer adjacent to the fourth inner layer, and a second outer layer, the second outer layer being a sealing layer. The total composition of the multilayer barrier film includes between 70% and 95%, by weight, polypropylene. The multilayer barrier film may have a total composition including less than or equal to 10%, by weight, EVOH copolymer, and less than or equal to 10%, by weight, polyamide polymer.

Also disclosed herein are retortable packages that include the multilayer barrier film. The retortable package may have a bottom web of a film that is thermoformed, and a top web of a film that is not thermoformed and at least one of the bottom web and the top web is made from the multilayer barrier film disclosed herein. Alternatively, the retortable package is in the form of a pouch having one or more sidewalls formed from the multilayer barrier film.

Significant advantages can be realized by producing and using the films described herein. Advantages include a rapid recovery of oxygen barrier properties after retort processing, within a thermoformable film, optimizing the shelf-life of the product packaged therein.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an embodiment of a multilayer barrier film;

FIG. 2 is a cross-sectional view of another embodiment of a multilayer barrier film;

FIG. 3 is a side view of a retortable package comprising a multilayer barrier film, the package including a top web and a bottom web;

FIG. 4 is a front view of a retortable package comprising a multilayer barrier film, the package in the form of a pouch;

FIG. 5 is a plot showing the oxygen transmission testing data after a retort process for an embodiment of the multilayer barrier film; and

FIG. 6 is another plot showing the oxygen transmission testing data after a retort process for an embodiment of the multilayer barrier film.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are embodiments of films and packages that are constructed from these films. The films are designed to have a previously unobtainable combination of properties including durable barrier, retort performance and recyclability. The durable barrier characteristics mean that the films can be subjected to flexing or thermoforming without significantly deteriorating the barrier performance. The retort performance characteristics mean that while the oxygen barrier of the film is slightly affected by the retort process, there is a fast recovery of properties such that the shelf life of the packaged product is not significantly affected. Retort performance characteristics also indicates that the films and packages survive the rather abusive retort process without significant appearance or hermeticity issues. The recyclability characteristics mean that the structure of the film is such that the film can be accepted into polyolefin-based recycling processes or otherwise recycled.

The multilayer barrier films embodiments described herein include many layers of specific polymer types, arranged according to a prescribed order. This arrangement of polymeric layers allows for the unique properties of barrier performance and recyclability. The unique properties of the multibarrier films make them specifically useful in embodiments of packages, thermoformed packages, pouches, retort packages or similar articles. Most notable of the characteristics of the films and packages is the barrier performance during retort processing and the recyclability, a combination that is otherwise very difficult to achieve.

One advantage of the films described herein is the ability to recycle the structures. As will be described, high performance polymers (i.e. polyamide polymers, EVOH copolymers and polyolefin polymers) are combined in a unique structure to maximize performance while maintaining recyclable attributes. The recyclability of the film is defined by the content of each of the polymers in the overall composition of the film, as will be described. Packages can be designed using the multilayer barrier films described herein and may also include similarly recyclable materials to produce a fully recyclable package.

Another advantage of the films and packages described herein can be described by the durable oxygen barrier performance. The films and packages can endure physical stress, such as thermoforming or flexing, without significant loss of oxygen barrier performance. The durability of the barrier is a result of the types of polymeric materials used to achieve the barrier, i.e. EVOH copolymer. However, it is known that EVOH can have significant post-retort barrier loss. In order to make the selection of EVOH as the oxygen barrier material in these films suitable for retort applications, the composition and position of the other layers within the structure becomes critical, as will be described herein. The films and packages display a surprisingly rapid recovery of oxygen barrier properties after exposure to heat and moisture, such as those that may be present during a retort sterilization process.

Surprisingly, the inventors of the films and packages described herein found that specific arrangements of specific polymeric materials within a multilayer barrier film were able to achieve these complex characteristics simultaneously. The films and packages are highly desirable for providing oxygen sensitive products packaged in recyclable packaging, the packaging significantly extending the shelf-life of the product.

As used herein, a “layer” is a homogeneous building block of films. A layer may contain a single material, or more often, include a blend of different materials. Layers may be continuous or discontinuous (i.e. patterned) with the length and width of the film. As used herein the term “film” may include a single layer or multiple connected layers. A film has an insignificant z-direction dimension (thickness) as compared to the x- and y-direction dimensions (length and width), not unlike a piece of paper. Both films and layers are generally regarded as having two surfaces, opposite each other, expanding in the length and width directions.

Films may be built from an unlimited number of films and/or layers, the films and/or layers being bonded together to form a composite article. Films may be produced by any means known in the art of polymeric films, such as the blown film extrusion process (making a blown film) or a cast film extrusion process (making a cast film). Layers of films may be combined by any means known in the art of polymeric films, such as coextrusion or lamination.

As used herein, the term “outer layer” is used to describe a layer that is located on one of the surfaces of the film in which it is comprised. As used herein, the term “inner layer” is used to describe a layer that is not located on the surface of the film in which it is comprised. An inner layer is adjacent to another layer at both of its surfaces.

As used herein, layers are “adjacent” if they are next to each other, with or without an intervening layer such as a bonding layer. As used herein, layers are “directly adjacent” if they share a common surface (i.e. they have an interface).

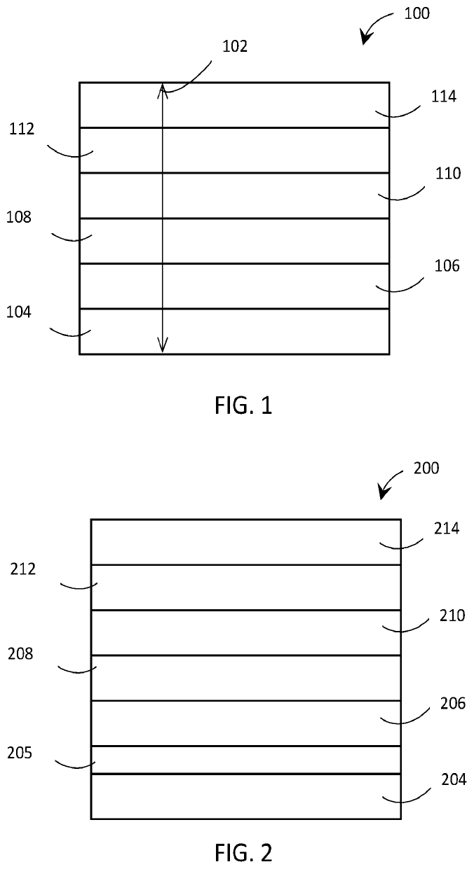

FIG. 1 depicts an embodiment of the multilayer barrier films having the unique combination of characteristics previously mention and further detailed herein. The multilayer barrier film 100 includes a first outer layer 114, a first inner layer 112, a second inner layer 110, a third inner layer 108, a fourth inner layer 106 and a second outer layer 104. The composition and details of each of these layers is further described below. In the embodiment shown in FIG. 1, first inner layer 112 is directly adjacent to first outer layer 114, second inner layer 110 is directly adjacent to first inner layer 112, third inner layer 108 is directly adjacent to second inner layer 110, fourth inner layer 106 is directly adjacent to third inner layer 108, and second outer layer 104 is directly adjacent to fourth inner layer 106. However, in other embodiments of the multilayer barrier film, one or more of these interfacing layers may be adjacent to each other and may have one or more intervening layers between them. If the multilayer barrier film includes one or more intervening additional layers, the order of layers remains: first outer layer, first inner layer, second inner layer, third inner layer, fourth inner layer, second outer layer.

The first outer layer of the multilayer barrier film includes a first polyamide polymer. As used herein, the term “polyamide” refers to homopolymers or copolymers having an amide linkage between monomer units which may be formed by any method known to those skilled in the art. Useful polyamide homopolymers include nylon 6 (polycaprolactam), and the like. Other useful polyamide homopolymers also include nylon 6,6 (polyhexamethylene adipamide). Useful polyamide copolymers include nylon 6,6/6 copolymer (polyhexamethylene adipamide/caprolactam copolymer), nylon 6/6,6 copolymer (polycaprolactam/hexamethylene adipamide copolymer), as well as other nylons which are not particularly delineated here. Other useful polyamides may be block copolymers of polyamide, such as the polyether/polyamide block copolymers sold under the tradename Pebax® MV 3000 by Arkema Technical Polymers. Further suitable copolymers include nylons sold under the tradename Ultramid® C33LN 01 (PA6/66 grade) by BASF and under the tradename 5033 FD825 (PA6/66) by UBE.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith. As used herein, the term “copolymer” refers to polymers formed by the polymerization of at least two different monomers.

The first outer layer includes a composition of up to 100% polyamide, by weight. The first outer layer may comprise more than one polyamide (i.e. a blend) and it may contain other components. The first outer layer includes a composition of greater than 50%, greater than 60%, greater than 70%, greater than 80%, or greater than 90% polyamide, by weight. For example, a first outer layer of a multilayer barrier film may contain between 70% and 100% polyamide or between 90% and 100% polyamide, by weight. The remainder of the composition of the first outer layer may include other polymers or additives such as slip or antiblock.

In some embodiments of the multilayer barrier film, the first outer layer may have a moisture vapor transmission rate (MVTR) between 10 gram·mil/100 in²/day and 80 gram·mil/100 in²/day. The first outer layer may have an MVTR between 10 gram·mil/100 in²/day and 40 gram·mil/100 in²/day.

In some embodiments of the multilayer barrier film, the polyamide polymer of the first outer layer may have an MVTR between 10 gram·mil/100 in²/day and 80 gram·mil/100 in²/day. The polyamide polymer of the first outer layer may have an MVTR between 10 gram·mil/100 in²/day and 40 gram·mil/100 in²/day.

Reference to “moisture vapor transmission rate” (MVTR) is the ability of a polymeric layer or material to transmit moisture therethrough as measured in accordance with ASTM-1249-13 entitled “Standard Test Method for Water Vapor Transmission Rate Through Plastic Film and Sheeting Using a Modulated Infrared Sensor.” Conditions for measurement include: atmospheric pressure, 38° C., and 90% relative humidity.

The thickness of the first outer layer may be from about 1 micron (0.039 mils) to about 100 microns (3.9 mils), and typically from about 2 microns (0.079 mils) to about 30 microns (1.18 mils) or about 4 microns (0.16 mils) to about 25 microns (0.98 mils).

The multilayer film comprises two or more inner layers containing ethylene vinyl alcohol (EVOH) copolymer (i.e. the first inner layer and the third inner layer). As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. The degree of hydrolysis is preferably from about 50 to 100 mole percent, more preferably from about 85 to 100 mole percent, and most preferably at least 97%. It is well known that to be a highly effective oxygen barrier, the hydrolysis-saponification must be nearly complete, i.e., to the extent of at least 97%. EVOH is commercially available in resin form with various percentages of ethylene and there is a direct relationship between ethylene content and melting point. It is expected that processability and orientation would be facilitated at higher ethylene contents; however, gas permeability, particularly with respect to oxygen, may become undesirably high for certain packaging applications which are sensitive to microbial growth in the presence of oxygen. Conversely, lower ethylene content may provide lower gas permeabilities, but processability and orientation may be more difficult. Preferably, EVOH comprises from about 27-48 mole % ethylene, or even 27-38 mole % ethylene.

The EVOH containing layers (i.e. the first inner layer and the third inner layer) independently may comprise a retortable EVOH. Reference to “retortable” EVOH copolymer is an EVOH copolymer in film-form that does not melt or otherwise degrade under “retort conditions”, which are exposure to high temperature steam or superheated water at ˜120° C.±5° C. for about 30 to 60 minutes at 30 pounds per square inch (psi) atmosphere. An exemplary EVOH is SoarnoL™ RB7405 (Soarus), which is a retortable EVOH having 29% ethylene.

In one or more embodiments, the EVOH-containing layers independently comprise greater than 97% to 100% EVOH. In one or more embodiments, the EVOH-containing layers each comprise 100% EVOH.

Each of the EVOH-containing layers is independently from about 1% to about 8%, by weight, as compared to the total composition of the entire multilayer barrier film. The total amount of EVOH-containing layers is 10% or less, or 5% or less, by weight. The total composition of the multilayer barrier film may include less than or equal to 10%, by weight, or less than or equal to 5%, by weight, of EVOH copolymer.

The two EVOH-containing layers (i.e. the first inner layer and the third inner layer) are separated by at least one inner layer, namely the second inner layer. The second inner layer is adjacent to the first inner layer. The second layer may be directly adjacent to the first inner layer. The second inner layer is adjacent to the third inner layer. The second inner layer may be directly adjacent to the third inner layer. The second inner layer may be directly adjacent to both the first inner layer and the third inner layer.

The second inner layer includes a polyolefin polymer. As used herein, the term “polyolefin” refers to a polyethylene polymer or a polypropylene polymer.

The second inner layer may include a polypropylene polymer. As used herein, the term “polypropylene” or “polypropylene polymer” refers to a plastomer, homopolymer or copolymer having at least one propylene monomer linkage within the repeating backbone of the polymer. The propylene linkage can be represented by the general formula: [CH₂—CH(CH₃)]ₙ. Such polypropylene may be a polypropylene impact copolymer or a polypropylene random copolymer, may be syndiotactic or isotactic and/or may or may not be clarified. In some embodiments of the multilayer barrier film, the second inner layer includes a maleic anhydride grafted polypropylene copolymer.

The second inner layer may include a polyethylene polymer. As used herein, the term “polyethylene” or “polyethylene polymer” refers to a homopolymer or copolymer having at least one ethylene monomer linkage within the repeating backbone of the polymer. Such polyethylene may be, but are not limited to, low-density polyethylene, linear low density polyethylene, medium-density polyethylene, or high-density polyethylene. In some embodiments of the multilayer barrier film, the second inner layer includes a maleic anhydride grafted high-density polyethylene.

The second inner layer may include a composition of up to 100% polypropylene, by weight. The second inner layer may comprise more than one polypropylene polymer (i.e. a blend) and it may contain other components. The second inner layer includes a composition of greater than 50%, greater than 60%, greater than 70%, greater than 80%, or greater than 90% polypropylene, by weight. For example, the second inner layer of a multilayer barrier film may contain between 70% and 100% polypropylene or between 90% and 100% polypropylene, by weight. The remainder of the composition of the second inner layer may include other polymers or additives.

The second inner layer may include a composition of up to 100% polyolefin polymer, by weight. The second inner layer may comprise more than one polyolefin polymer (i.e. a blend) and it may contain other components. The second inner layer includes a composition of greater than 50%, greater than 60%, greater than 70%, greater than 80%, or greater than 90% polyolefin, by weight. For example, the second inner layer of a multilayer barrier film may contain between 70% and 100% polyolefin or between 90% and 100% polyolefin, by weight. The remainder of the composition of the second inner layer may include other polymers or additives.

The thickness of the second inner layer may be from about 4 micron (0.16 mils) to about 38 microns (1.5 mils), and typically from about 8 microns (0.31 mils) to about 32 microns (1.25 mils) or about 10 microns (0.4 mils) to about 25.4 microns (1.0 mils).

In some embodiments of the multilayer barrier film, the second inner layer may have a moisture vapor transmission rate (MVTR) between 0.5 gram·mil/100 in²/day and 10 gram·mil/100 in²/day. The second inner layer may have an MVTR between 1 gram·mil/100 in²/day and 5 gram·mil/100 in²/day.

In some embodiments of the multilayer barrier film, the polyolefin polymer of the second inner layer may have an MVTR between 0.5 gram·mil/100 in²/day and 10 gram·mil/100 in²/day. The polyolefin polymer of the second inner layer may have an MVTR between 1 gram·mil/100 in²/day and 5 gram·mil/100 in²/day.

The use of a polypropylene polymer in the second inner layer may provide some improved mechanical performance during retort processing, reducing whitening and preventing other defects.

The fourth inner layer of the multilayer barrier film may include a polyamide polymer. The polyamide polymer may be the same or different than the polyamide polymer present in the first outer layer. The fourth inner layer may include a composition of up to 100% polyamide, by weight. The fourth inner layer may comprise more than one polyamide (i.e. a blend) and it may contain other components. The fourth inner layer may include a composition of greater than 50%, greater than 60%, greater than 70%, greater than 80%, or greater than 90% polyamide, by weight. For example, the fourth inner layer of a multilayer barrier film may contain between 70% and 100% polyamide or between 90% and 100% polyamide, by weight.

The fourth layer of the multilayer barrier film may include a polyolefin polymer. The polyolefin polymer may be the same or different than the polyolefin polymer present in the second inner layer. The fourth inner layer may include a composition of up to 100% polyolefin, by weight. The fourth inner layer may comprise more than one polyolefin (i.e. a blend) and it may contain other components. The fourth inner layer may include a composition of greater than 50%, greater than 60%, greater than 70%, greater than 80%, or greater than 90% polyolefin polymer, by weight. For example, the fourth inner layer of a multilayer barrier film may contain between 70% and 100% polyolefin polymer or between 90% and 100% polyolefin polymer, by weight. The fourth inner layer may include a maleic anhydride grafted high-density polyethylene.

The fourth layer of the multilayer barrier film may include a polypropylene copolymer. The polypropylene copolymer may be the same or different than the polypropylene copolymer present in the second inner layer. The fourth inner layer may include a composition of up to 100% polypropylene, by weight. The fourth inner layer may comprise more than one polypropylene (i.e. a blend) and it may contain other components. The fourth inner layer may include a composition of greater than 50%, greater than 60%, greater than 70%, greater than 80%, or greater than 90% polypropylene, by weight. For example, the fourth inner layer of a multilayer barrier film may contain between 70% and 100% polypropylene or between 90% and 100% polypropylene, by weight. The fourth inner layer may include a maleic anhydride grafted polypropylene copolymer.

The fourth inner layer is adjacent to the third inner layer. The fourth inner layer is between the third inner layer and the second outer layer. The fourth inner layer may be directly adjacent to the third inner layer.

Adjacent to the fourth inner layer is a second outer layer. The second outer layer may include multiple layers, or it may be a single layer. The second outer layer includes a sealing layer. A “sealing layer” is one that can be heat sealed to itself or another sealing layer to form a bond. That is, the sealing layer comprises a thermoplastic polymer or polymer mixture that softens when exposed to heat or other energy sources and returns to its original condition when cooled to room temperature. In order to be useful as a sealing layer, the sealing layer is an outer layer of the second outer layer and the sealing layer is an outer layer of the multilayer barrier film. When the multilayer barrier film is used in a package, the sealing layer is oriented toward the inside of the package (i.e. exposed to the packaged product) and the sealing layer is used to form a hermetic seal, hermetically sealing a product inside the package.

The second outer layer may be a mono-layer film. In some embodiments, the second outer layer is a multilayer film, the film containing two or more layers. In this case, at least one of the surface layers of the second outer layer is a sealing layer, and this sealing layer is oriented away from the inner layers of the multilayer barrier film.

The composition of the fourth layer may be greater than 80% polypropylene, greater than 85% polypropylene or greater than 90% polypropylene, by weight. The composition of the fourth layer may be 100% polypropylene, by weight.

The composition of the sealing layer may be greater than 80% polypropylene, greater than 85% polypropylene or greater than 90% polypropylene, by weight. The composition of the sealing layer may be 100% polypropylene, by weight.

Some embodiments of a multilayer barrier film include a sealing layer comprising (e.g., in a major amount of greater than 50% by weight) or consists essentially of (1) a polypropylene or (2) a blend of polypropylene and at least one other polyolefin. Polyolefins appropriate for the sealing layer include, but are not limited to, polyolefin plastomers, such as, for example polyethylene that may be blended in the sealing layer. The sealing layer may also comprise (e.g., in a major amount of greater than 50% by weight) or consist essentially of (i) a cast retortable grade polypropylene (ii) a coextruded polypropylene polymer or copolymer, or (iii) a blend of a coextruded polypropylene polymer or copolymer and at least one other polyolefin. In one particular embodiment, the sealing layer comprises 100% by weight of cast retortable grade polypropylene. A representative cast retortable grade polypropylene has a density of about 0.9 g/cm³ (e.g., in the range from about 0.85 g/cm³ to about 0.95 g/cm³) and melt flow index of 2.1 g/10 min (e.g., in the range from about 1.9 g/10 min to about 2.3 g/10 min).

The second outer layer should incorporate a sealing layer that has a relatively low seal initiation temperature. The seal initiation temperature of the sealing layer should be comfortably (i.e. at least 5 to 10° C.) lower than the sealing temperature that causes significant damage (i.e. shrinking, deforming, sticking, etc.) to the first outer layer. Even though the sealing layer has a rather low temperature softening point, the sealing layer still has enough integrity to survive the high temperatures of the retort sterilization process along with other abuses a package may endure during distribution and use.

The thickness of the second outer layer (i.e. the sealing layer) is generally from about 1 micron (0.039 mils) to about 75 microns (3.0 mils), and typically from about 2 microns (0.079 mils) to about 25 microns (0.98 mils).

Some embodiments of the multilayer barrier film may include additional layers. These layers may be in any position and may have any function or composition as long as they do not interfere with the spirit of the disclosed films. For example, FIG. 2 shows an embodiment of a multilayer barrier film 200 that includes an adhesive layer 205. Overall, this embodiment includes a first outer layer 214 containing a polyamide polymer, a first inner layer 212 containing an EVOH copolymer, a second inner layer 210 containing a polypropylene polymer, a third inner layer 208 containing an EVOH copolymer, a fourth inner layer 206 containing a polyamide polymer, a second outer layer 204 containing a sealing layer, and an adhesive layer 205 bonding the second outer layer 204 to the fourth inner layer 206. As shown, an embodiment of the multilayer barrier film may have the named layers directly adjacent to each other. In other embodiments, the layers may be adjacent to each other, but one or more of the adjacent layers may have one or more additional layers intervening. Adhesive layer 205 is an example of an additional intervening layer. If the multilayer barrier film includes one or more intervening additional layers, the order of layers remains: first outer layer, first inner layer, second inner layer, third inner layer, fourth inner layer, second outer layer.

The term “tie layer” or “adhesive layer” refers to a layer containing a specialized material to promote the adhesion of that layer to another surface. Preferably, adhesive layers or tie layers are positioned between two layers of a multilayer film to maintain the two layers in position relative to each other and prevent undesirable delamination (i.e. separation). Unless otherwise indicated, a tie layer or an adhesive layer can have any suitable composition that provides a desired level of adhesion with the one or more surfaces in contact with the adhesive layer.

Other examples of additional layers include, but are not limited to, ink or overlacquer. These materials may be in any location of the film including the surface. However, inks are preferably located within the film structure (i.e. not on the surface, between film layers) in order to protect them from scuffing or other physical abuse.

The multilayer barrier films, as well as containers having such films, preferably have seal strength, stability, heat resistance, and oxygen and water vapor transmission properties that allow them to be subjected to retort conditions without loss of desired functional characteristics. The films disclosed herein may also be used for pasteurization purposes.

For example, after exposure to retort conditions, a seal strength is generally from about 5 N/15 mm (863 g/in) to about 100 N/15 mm (17,267 g/in), and typically from about 6 N/15 mm (1,036 g/in) to about 50 N/15 mm (8,634 g/in), according to ASTM-F88 with a crosshead speed of 12 in/min (30.48 cm/min). Advantageously, seal strength retention (comparing before and after retort) is also exhibited, based on a loss in seal strength of generally less than about 35%, typically less than about 20%, and often less than about 10%, upon being subjected to retort conditions.

Furthermore, multilayer films described herein also have acceptable heat resistance, in terms of resisting delamination or other visible defects. Preferably, no delamination of the film structure is observed after the film is subjected to 100° C. (212° F.) for 30 minutes, or even for 60 minutes.

Representative multilayer films are also in compliance with regulations set forth under 21 C.F.R. § 177.1390, hereby incorporated by reference.

As shown in FIG. 1, the multilayer barrier film also has a total thickness 102. The thickness of the multilayer film may have a minimum of about 50.8 microns (2.0 mils), about 76.2 microns (3.0 mils), about 101.6 microns (4 mils) or about 127 microns (5 mils). The thickness of the multilayer barrier film may have a maximum of about 254 microns (10 mils), about 381 microns (15 mils), about 508 microns (20 mils), about 762 microns (30 mils) or about 1,143 microns (45 mils). For example, the total thickness of a representative, multilayer film, as described herein, which may be used in the formation of retortable containers is generally in a range of from about 76.2 microns (3.0 mils) to about 1,143 microns (45 mils), or in the range of from about 101.6 microns (4 mils) to about 760 microns (29.9 mils).

The multilayer barrier films are useful for thermoformed packaging applications. As used herein, the term “thermoformed” or “thermoformable” refers to a film or sheet material that has been or can be permanently shaped (i.e. a film that has been shaped to be outside the original x-y plane) by using a process that uses heat and pressure. The film or sheet material is of a composition that upon heating to an elevated temperature, the material becomes soft but not melted, allowing the reshaping process. In general, thermoplastic materials can be thermoformed and inorganic materials (metals or oxides) are not thermoformable. Additionally, the multilayer barrier film may be partially or completely unoriented, as high levels of orientation are detrimental to thermoforming properties.

While the structure of the multilayer barrier film and any packages made therefrom contain several different layers (outer layers, inner layers, sealing layer, etc.) having various composition, the total composition of the film or package should have high levels of a single material type, specifically polypropylene, to facilitate recycling. As used herein, the term “total composition” is used to describe the materials included in the entire film structure or package. Any materials, layers or components that are connected to one another in any way are part of the total composition of that article. The total composition of the multilayer barrier films may include high levels of polyolefin polymer. The total composition of packages made using the multilayer barrier films may have high levels of polyolefin polymer. The multilayer barrier films described herein, and any retort packages made therefrom, may be recyclable in a polyolefin recycling process when the article includes a total composition including high amounts of polyolefin polymer. A mixed polyolefin recycling process can also accept relatively high levels of polyolefins that are not polypropylene, so the total composition of the articles may also contain high levels of polyolefins that are not polypropylene and still be suitable for recycling.

In one or more embodiments, the multilayered films comprise less than or equal to 10%, by weight, of EVOH materials or less than or equal to 5%, by weight. In one or more embodiments, the multilayered films comprise less than or equal to 10%, by weight, of polyamide materials or less than or equal to 5%, by weight. In one or more embodiments, the multilayered films comprise both EVOH materials and polyamide materials in independent amounts of less than or equal to 10%, by weight, or less than or equal to 5%, by weight.

The multilayer barrier film may have a total composition including at least 70% polypropylene polymers, by weight. In other words, considering all of the materials (polymeric and non-polymeric) within the entire multilayer barrier film, at least 70% by weight are polypropylene polymers. The multilayer barrier film may have a total composition including a minimum polypropylene polymer content of 70%, 75%, 80%, 85%, or 90%, by weight. The multilayer barrier film may have a total composition including a maximum polypropylene polymer content of 100%, 99%, 98%, 97%, 96% or 95%, by weight. For example, the multilayer barrier film may have a total composition having from 80% to 98% polypropylene polymer or the multilayer barrier film may have a total composition having from 75% to 95% polypropylene polymer, by weight.

The multilayer barrier film may have a total composition including at least 70% polyolefin polymer, by weight. In other words, considering all of the materials (polymeric and non-polymeric) within the entire multilayer barrier film, at least 70% by weight are polyolefin polymers. The multilayer barrier film may have a total composition including a minimum polyolefin polymer content of 70%, 75%, 80%, 85%, or 90%, by weight. The multilayer barrier film may have a total composition including a maximum polyolefin polymer content of 100%, 99%, 98%, 97%, 96% or 95%, by weight. For example, the multilayer barrier film may have a total composition having from 80% to 98% polyolefin polymer or the multilayer barrier film may have a total composition having from 75% to 95% polyolefin polymer, by weight.

In some embodiments, the multilayer barrier film has a total composition that includes less than 25%, less than 20%, less than 15% or less than 10% polymers other than polyolefin polymers, by weight. In some embodiments, the multilayer barrier film has a total composition that includes less than 25%, less than 20%, less than 15% or less than 10% polymers other than polypropylene polymers, by weight. In addition to having high polyolefin and polypropylene content, the multilayer barrier film may have low levels of non-polyolefin polymers, with respect to the total composition.

Examples of non-polyolefin polymers that may be included in the multilayer film include polyamides, EVOH, polyacrylates and polyurethanes. One or more of these polymers may be present in an extruded layer or within a printed ink or adhesive layer. The multilayer barrier film may have a total composition that includes less than 20%, less than 15%, less than 10%, or less than 5% polymers other than polyolefin polymers, by weight. The multilayer barrier film may have a total composition that includes less than 20%, less than 15%, less than 10%, or less than 5% polymers other than polypropylene polymers, by weight.

The total composition of the multilayer barrier film is optimized to deliver performance, especially robustness through retort, and recyclability. The combination of the total composition of the multilayer barrier film and the structure of specific layers disclosed herein provide for an advantageous combination of characteristics that was previously unavailable. The combination of features provides for extended shelf life (due to rapid recovery of barrier after retort), thermoformability and overall durability.

The layers of the multilayer barrier film may be combined by any process or any combination of processes without limitation. For example, an embodiment of the multilayer barrier film may contain six or more layers, each of the layers being combined in a blown film coextrusion process. That film may then have an additional ink layer added to the first outer layer by way of a printing process. Alternatively, several of the layers of an embodiment of the multilayer barrier film may be coextruded by way of a cast extrusion process, and the remaining layers are added by a lamination process utilizing an adhesive layer for bonding.

As used herein, a “retort packaging film”, “retortable package” or “retort packaging” is a film, or package made from the film, that can be filled with product, sealed, and remain hermetically sealed after being exposed to a typical retort sterilization process. Typical retort sterilization is a batch process that uses temperatures from about 100° C. to about 150° C., over-pressure up to about 70 psi (483 kPa), and may have a duration from a few minutes up to several hours. Common retort processes used for products packaged in flexible films include steam or water immersion. Some products (i.e. food or others) packaged in retort packaging film and retort sterilized can be stored at ambient conditions for extended periods of time (i.e. are shelf-stable), retaining sterility. Because the retort process is incredibly abusive, very specialized flexible packaging films have been designed to survive the process.

The multilayer barrier films described herein are advantageous for any component of a package, specifically a retort package, more specifically a thermoformed retort package. For example, the films herein are suitable for a semi-rigid or flexible thermoformed web. The films herein are also suitable for a non-thermoformed lid to accompany the semi-rigid or flexible thermoformed web. Advantageously, the multilayered films herein provide a durable oxygen barrier layer while being handled and processed in different ways. A benefit of the multilayered films herein relative to other retortable packaging film structures containing other types of barrier materials, for example, AlOx or SiOx, is the multilayered films herein can be deep-drawn by thermoforming. The multilayer barrier films herein can also be otherwise stretched and abused without compromising the oxygen barrier.

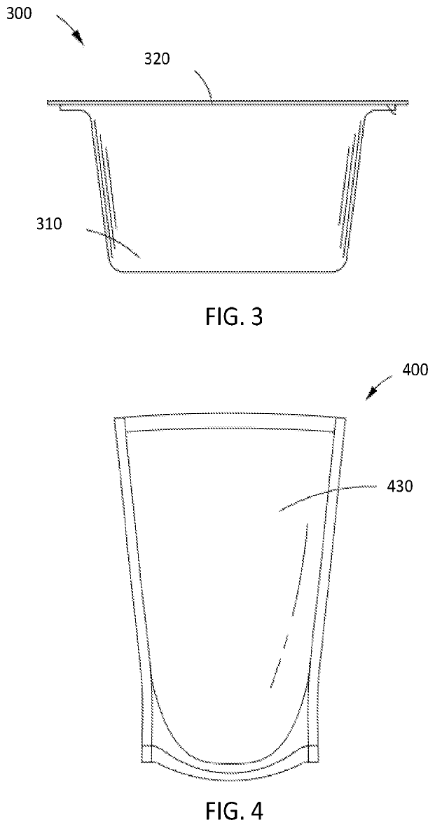

FIG. 3 is a side view of an exemplary retortable package 300 having a top web 320 and a bottom web 310. The bottom web 310 is according to any multilayer barrier film of the disclosure. The bottom web 310 is thermoformed to provide a cavity to hold a packaged product. The top web 320 is heat-sealed to the bottom web 310 to form the cavity to hold and hermetically protect the packaged product. The top web 320 is made of a film that may be the same or different as that of the bottom web 310. The top web 320 may be thermoformed, otherwise formed, or unformed.

Alternatively, the retortable package 300 shown in FIG. 3 could use a top web 320 according to any multilayer barrier film of the disclosure and a bottom web 310 that is not according to the disclosure.

FIG. 4 is a side view of an exemplary retortable container 400 in the form of a stand-up pouch, which may be suitable for packaging. Pouch 400 comprises a sidewall 430 of a material according to any multilayer barrier film of the disclosure. Additionally, the bottom gusset (not shown) may be formed from any film of the disclosure.

Some embodiments of the multilayer barrier films disclosed herein may be especially suited to performing well in the stand-up pouch configuration shown in FIG. 4. This configuration is especially demanding as the sealing layer is required to seal well in multiple triple-point locations (i.e. at the top of the gusset in the side seals), the sealing layer must seal at a temperature low enough to prevent scorching/marring/shrinking of the first outer layer, and the barrier must withstand significant flexing in the gusset area of the pouch.

### EXAMPLES

Two example multilayer barrier films were assembled for testing. Details of Examples 1 and 2 can be found in Table 1 below.

Each of Examples 1 and 2 were two-ply laminations and included a polypropylene based sealant film that is a cast film (100% polypropylene-based materials) and a polyamide and EVOH containing multilayer film (80% polypropylene-based materials).

The films were bonded together using adhesive lamination. The adhesive used for Example 1 was a solvent based two-component system of Dow Adcote™ 577 and Catalyst CR 78-124, available from Dow Chemical. Example 2 also used a solvent based two component adhesive system.

The polyamide and EVOH containing films used in Examples 1 and 2 (i.e. multilayer film 1 and multilayer film 2, respectively) were produced utilizing a multilayer coextrusion process. These multilayer films incorporated alternating layers of PA, EVOH, and polypropylene materials as denoted in Table 1. The multilayers were composed of a first outer layer of polyamide, adjacent to a first inner layer of EVOH. The EVOH first inner layer was adjacent to a second inner layer of a first polypropylene polymer. A third inner layer adjacent to the second inner layer was composed of EVOH. Adjacent to the third inner layer was a fourth inner layer of polyamide. A fifth inner layer of the first polypropylene polymer was adjacent to the fourth inner layer. A sixth inner layer of a second polypropylene polymer was adjacent to the fifth inner layer. The first outer and fourth inner layers contained 1024FD50 polyamide supplied by UBE Industries. The first and third inner layers contained Soranol RB7405B EVOH produced by Mitsubishi Chemical. The second and fifth inner layers used a first polypropylene copolymer grade of Admer QF500A (PP Copolymer 1) available from Mitsui Chemicals. The sixth inner layer of a second polypropylene copolymer consisted of a blend of grades 4710, Q100F, and 9054 (PP Copolymer 2) as supplied by Total, Lyondell Basell, and Exxon Mobil respectively. A relatively small percentage of processing additives (i.e. slip and antiblock) were added to the multilayer film, amounting to less than 0.1% by weight of the total structure.

For each layer of the films of Examples 1 and 2, the amount of polypropylene-based material is reported in Table 1. The cast polypropylene films used contained 100% polypropylene-based materials. The polyamide and EVOH containing multilayer film used over 80% polypropylene-based materials. The adhesives were based on other polymers, thus containing 0% polypropylene-based materials. The total composition of Examples 1 and 2, as it relates to polypropylene-based materials (PP), EVOH materials, and polyamide materials, as a percentage by weight is reported in Tables 1 and 2, respectively.

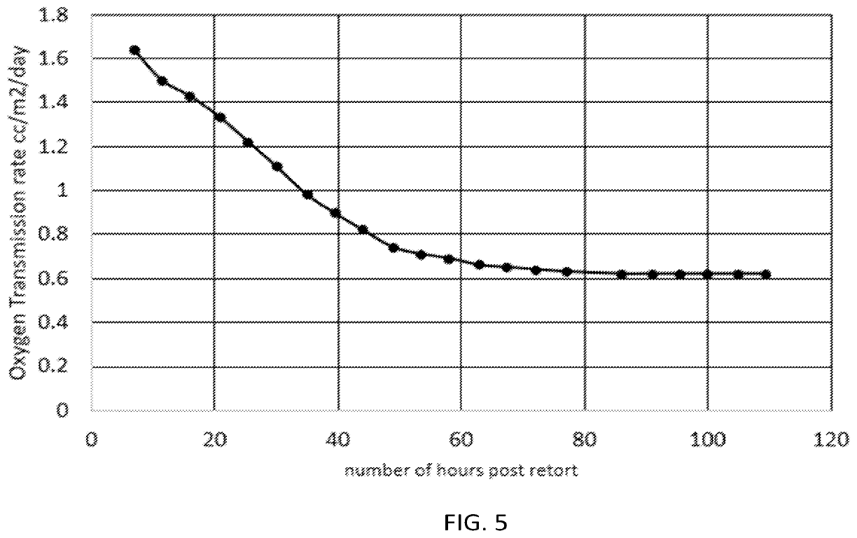

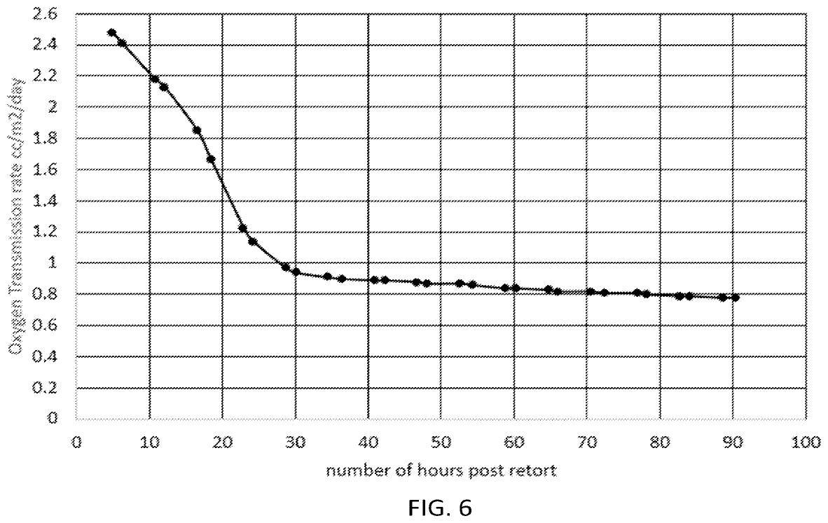

The oxygen transmission rate (OTR) is reported for each of Examples 1 and 2, shown in FIGS. 5 and 6, respectively. The OTR was measured according to ASTM F1927 using conditions of 1 atmosphere, 23C and 50% RH. The post-retort OTR of Example 1 was measured after exposing the retort packaging film to a representative retort sterilization process, cutting a DIN A4 sized portion of the retort packaging film and exposing it to a steam sterilization process for 10 minutes at 250° F. and overpressure of 2.5 bar, followed by water shower cooling. The post-retort OTR of Example 2 was measured after exposing the retort packaging film to a representative retort sterilization process, cutting a DIN A4 sized portion of the retort packaging film and exposing it to a water spray sterilization process for 60 minutes at 254° F. and overpressure of 30 psi, followed by water shower cooling. The retort packaging films retain excellent OTR even after exposure to retort processing.

TABLE 1
Film structures and compositions for Example 1

| | | Layer | PP | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| Cast PP Film | | 55.91 | 55.91 | 0 | 0 |
| adhesive | | 2.35 | 0 | 0 | 0 |
| multi- | PP | 24.83 | 24.83 | 0 | 0 |
| layer | Copolymer 2 | | | | |
| film 1 | PP | 7.69 | 7.69 | 0 | 0 |
| | Copolymer 1 | | | | |
| | PA | 8.13 | 0 | 8.13 | 0 |
| | EVOH | 5 | 0 | 0 | 5 |
| | PP | 6.26 | 6.26 | 0 | 0 |
| | Copolymer 1 | | | | |
| | EVOH | 7.51 | 0 | 0 | 7.51 |
| | PA | 3.13 | 0 | 3.13 | 0 |

| | | | |
|---|---|---|---|
| Total composition: | 78.4% PP | 9.3% poly- | 10% EVOH |
| | | amide | |

TABLE 2
Film structures and compositions for Example 2

| | | Layer | PP | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| Cast PP Film | | 56.3 | 56.3 | 0 | 0 |
| adhesive | | 1.6 | 0 | 0 | 0 |
| multi- | PA | 1.66 | 0 | 1.66 | 0 |
| layer | EVOH | 3.32 | 0 | 0 | 3.32 |
| film 2 | PP | 6.64 | 3.13 | 0 | 0 |
| | Copolymer | | | | |
| | (PP tie/PP/ | | | | |
| | PP tie) | | | | |
| | EVOH | 3.32 | 0 | 0 | 3.32 |
| | PA | 1.67 | 0 | 1.67 | 0 |

| | | | |
|---|---|---|---|
| Total composition: | 84.5% PP | 4.4% poly- | 8.9% EVOH |
| | | amide | |

### PROPHETIC EXAMPLES

Tables 3, 4, 5 and 6 include four other film structures, prophetic Examples A, B, C and D, respectively, that are according to the described multilayer barrier film and would provide the same advantages.

The polyolefin content (polyethylene plus polypropylene) of Prophetic Example A is 80%, by weight. The polypropylene content of Prophetic Example A is 72.4%, by weight. The polyethylene content of Prophetic Example A is 7.6%, by weight.

TABLE 3
Film structures and compositions for Prophetic Example A

| | | Layer | PP | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| PP Film | | 55.91 | 55.91 | 0 | 0 |
| adhesive | | 2.35 | 0 | 0 | 0 |
| multi- | PP- | 17.41 | 12.41 | 0 | 0 |
| layer | HDPE | | | | |
| film | PP- | 17.41 | 12.41 | 0 | 0 |
| | HDPE | | | | |
| | PP tie | 7.69 | 7.69 | 0 | 0 |
| | PA | 8.13 | 0 | 8.13 | 0 |
| | EVOH | 5 | 0 | 0 | 5 |
| | PP tie | 6.26 | 6.26 | 0 | 0 |
| | EVOH | 7.51 | 0 | 0 | 7.51 |
| | PA | 3.13 | 0 | 3.13 | 0 |

| | | | |
|---|---|---|---|
| Total composition: | 72.4% PP | 8.6% poly- | 9.6% EVOH |
| | | amide | |

The polyolefin content (polyethylene plus polypropylene) of Prophetic Example B is 81.8%, by weight. The polypropylene content of Prophetic Example B is 81.8%, by weight.

TABLE 4
Film structures and compositions for Prophetic Example B

| | | Layer | PP | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| Cast PP Film | | 75.2 | 75.2 | 0 | 0 |
| adhesive | | 1.6 | 0 | 0 | 0 |
| multi- | PP | 24.83 | 24.83 | 0 | 0 |
| layer | PP tie | 7.69 | 7.69 | 0 | 0 |
| film | PA | 8.13 | 0 | 8.13 | 0 |
| | EVOH | 5 | 0 | 0 | 5 |
| | PP tie | 6.26 | 6.26 | 0 | 0 |
| | EVOH | 7.51 | 0 | 0 | 7.51 |
| | PA | 3.13 | 0 | 3.13 | 0 |

| | | | |
|---|---|---|---|
| Total composition: | 81.8% PP | 8.1% poly- | 9.0% EVOH |
| | | amide | |

The polyolefin content (polyethylene plus polypropylene) of Prophetic Example C is 87.6%, by weight. The polypropylene content of Prophetic Example C is 87.6%, by weight.

TABLE 5
Film structures and compositions for Prophetic Example C

| | | Layer | PP | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| Cast PP Film | | 75.2 | 75.2 | 0 | 0 |
| adhesive | | 1.6 | 0 | 0 | 0 |
| multi- | PP | 24.83 | 24.83 | 0 | 0 |
| layer | PP | 7.69 | 7.69 | 0 | 0 |
| film | PP tie | 8.13 | 8.13 | 0 | 0 |
| | EVOH | 5 | 0 | 0 | 5 |
| | PP tie | 6.26 | 6.26 | 0 | 0 |
| | EVOH | 7.51 | 0 | 0 | 7.51 |
| | PA | 3.13 | 0 | 3.13 | 0 |

| | | | |
|---|---|---|---|
| Total composition: | 87.6% PP | 2.2% poly- | 9.0% EVOH |
| | | amide | |

The polyolefin content (polyethylene plus polypropylene) of Prophetic Example D is 83.6%, by weight. The polypropylene content of Prophetic Example D is 7.5%, by weight. The polyethylene content of Prophetic Example D is 76.16%, by weight.

TABLE 6
Film structures and compositions for Prophetic Example D

| | | Layer | PE | Polyamide | EVOH |
|---|---|---|---|---|---|
| | | Wt. | Wt. | Wt. | Wt. |
| Structure | | (lb/rm) | (lb/rm) | (lb/rm) | (lb/rm) |
| HDPE-PP Film | | 56.3 | 50.67 | 0 | 0 |
| adhesive | | 2.35 | 0 | 0 | 0 |
| | PA | 1.66 | 0 | 1.66 | 0 |
| | EVOH | 3.32 | 0 | 0 | 3.32 |
| | PE tie | 6.64 | 6.64 | 0 | 0 |
| | (HDPE tie) | | | | |
| | EVOH | 3.32 | 0 | 0 | 3.32 |
| | PA | 1.66 | 0 | 1.67 | 0 |

| | | | |
|---|---|---|---|
| Total composition: | 76.16% PE | 4.4% poly- | 8.8% EVOH |
| | | amide | |

### Embodiments

A. A multilayer barrier film comprising:
a first outer layer comprising a first polyamide polymer;
a first inner layer adjacent to the first outer layer, the first inner layer comprising a first ethylene vinyl alcohol (EVOH) copolymer;
a second inner layer adjacent to the first inner layer, the second inner layer comprising a first polyolefin polymer;
a third inner layer adjacent to the second inner layer, the third inner layer comprising a second ethylene vinyl alcohol (EVOH) copolymer;
a fourth inner layer adjacent to the third inner layer, the fourth inner layer comprising a second polyamide polymer or a second polyolefin polymer; and
a second outer layer comprising a sealing layer;
wherein the multilayer barrier film comprises a total composition comprising less than or equal to 10%, by weight, EVOH copolymer, and less than or equal to 10%, by weight, polyamide polymer.

B. The multilayer barrier film according to embodiment A wherein the sealing layer comprises a polypropylene copolymer.

C. The multilayer barrier film according to any previous embodiment wherein the sealing layer is part of a cast film or a blown film.

D. The multilayer barrier film according to any previous embodiment wherein the total composition of the multilayer barrier film comprises less than or equal to 5%, by weight, EVOH copolymer.

E. The multilayer barrier film according to any previous embodiment further comprising a thickness between 3 mil and 20 mil.

F. The multilayer barrier film according to any previous embodiment wherein the total composition of the multilayer barrier film comprises between 70% and 95%, by weight, polyolefin.

G. The multilayer barrier film according to any previous embodiment wherein the total composition of the multilayer barrier film comprises between 70% and 95%, by weight, polypropylene.

H. The multilayer barrier film according to any previous embodiment wherein the first ethylene vinyl alcohol (EVOH) copolymer is retortable.

I. The multilayer barrier film according to any previous embodiment wherein the second ethylene vinyl alcohol (EVOH) copolymer is retortable.

J. The multilayer barrier film according to any previous embodiment wherein the first outer layer comprises a moisture vapor transmission rate (MVTR) of greater than or equal to 10 gram·mil/100 in²/day.

K. The multilayer barrier film according to any previous embodiment, wherein the moisture vapor transmission rate (MVTR) of the first polyamide polymer is between 10 gram·mil/100 in²/day and 40 gram·mil/100 in²/day.

L. The multilayer barrier film according to any previous embodiment, wherein the first outer layer is in direct contact with the first inner layer, the first inner layer is in direct contact with the second inner layer, and the second inner layer is in direct contact with the third inner layer.

M. The multilayer barrier film according to any previous embodiment, wherein the multilayer barrier film is thermoformable.

N. The multilayer barrier film according to any previous embodiment further comprising an adhesive layer located between the fourth inner layer and the second outer layer.

O. The multilayer barrier film according to any previous embodiment wherein the first polyolefin polymer is a maleic anhydride grafted polypropylene copolymer.

P. A multilayer barrier film for food packaging comprising:
a first outer layer comprising a first polyamide polymer;
a first inner layer adjacent to the first outer layer, the first inner layer comprising a first ethylene vinyl alcohol (EVOH) copolymer;
a second inner layer adjacent to the first inner layer, the second inner layer comprising a first polypropylene copolymer;
a third inner layer adjacent to the second inner layer, the third inner layer comprising a second ethylene vinyl alcohol (EVOH) copolymer;
a fourth inner layer adjacent to the third inner layer, the fourth inner layer comprising a second polyamide polymer;
an adhesive layer adjacent to the fourth inner layer;
a second outer layer comprising a sealing layer; and
a total composition comprising between 70% and 95%, by weight, polypropylene.

Q. The multilayer barrier film of embodiment P, wherein the total composition of the multilayer barrier film comprises less than or equal to 10%, by weight, EVOH copolymer, and less than or equal to 10%, by weight, polyamide polymer.

R. A retortable package comprising the multilayer barrier film of any previous embodiment.

S. The retortable package of embodiment R comprising a bottom web comprising a film that is thermoformed, and a top web comprising a film that is not thermoformed; wherein at least one of the bottom web and the top web comprise the multilayer barrier film.

T. The retortable package of embodiment R in the form of a pouch comprising one or more sidewalls formed from the multilayer barrier film.

What is claimed is:

1. A multilayer barrier film comprising:
a first outer layer comprising a first polyamide polymer;
a first inner layer adjacent to the first outer layer, the first inner layer comprising a first ethylene vinyl alcohol (EVOH) copolymer;
a second inner layer adjacent to the first inner layer, the second inner layer comprising a first polyolefin polymer;
a third inner layer adjacent to the second inner layer, the third inner layer comprising a second ethylene vinyl alcohol (EVOH) copolymer;
a fourth inner layer adjacent to the third inner layer, the fourth inner layer comprising a second polyamide polymer or a second polyolefin polymer; and
a second outer layer comprising a sealing layer;
wherein the multilayer barrier film comprises a total composition comprising less than or equal to 10%, by weight, EVOH copolymer, and less than or equal to 10%, by weight, polyamide polymer.

2. The multilayer barrier film according to claim 1 wherein the sealing layer comprises a polypropylene copolymer.

3. The multilayer barrier film according to claim 2 wherein the sealing layer is part of a cast film or a blown film.

4. The multilayer barrier film according to claim 1 wherein the total composition of the multilayer barrier film comprises less than or equal to 5%, by weight, EVOH copolymer.

5. The multilayer barrier film according to claim 1 further comprising a thickness between 3 mil and 20 mil.

6. The multilayer barrier film according to claim 1 wherein the total composition of the multilayer barrier film comprises between 70% and 95%, by weight, polyolefin.

7. The multilayer barrier film according to claim 1 wherein the total composition of the multilayer barrier film comprises between 70% and 95%, by weight, polypropylene.

8. The multilayer barrier film according to claim 1 wherein the first ethylene vinyl alcohol (EVOH) copolymer is retortable.

9. The multilayer barrier film according to claim 1 wherein the second ethylene vinyl alcohol (EVOH) copolymer is retortable.

10. The multilayer barrier film according to claim 1 wherein the first outer layer comprises a moisture vapor transmission rate (MVTR) of greater than or equal to 10 gram·mil/100 in²/day.

11. The multilayer barrier film according to claim 1, wherein the moisture vapor transmission rate (MVTR) of the first polyamide polymer is between 10 gram·mil/100 in²/day and 40 gram·mil/100 in²/day.

12. The multilayer barrier film according to claim 1, wherein the first outer layer is in direct contact with the first inner layer, the first inner layer is in direct contact with the second inner layer, and the second inner layer is in direct contact with the third inner layer.

13. The multilayer barrier film according to claim 1, wherein the multilayer barrier film is thermoformable.

14. The multilayer barrier film according to claim 1 further comprising an adhesive layer located between the fourth inner layer and the second outer layer.

15. The multilayer barrier film according to claim 1 wherein the first polyolefin polymer is a maleic anhydride grafted polypropylene copolymer.

16. A multilayer barrier film for food packaging comprising:
a first outer layer comprising a first polyamide polymer;
a first inner layer adjacent to the first outer layer, the first inner layer comprising a first ethylene vinyl alcohol (EVOH) copolymer;
a second inner layer adjacent to the first inner layer, the second inner layer comprising a first polypropylene copolymer;
a third inner layer adjacent to the second inner layer, the third inner layer comprising a second ethylene vinyl alcohol (EVOH) copolymer;
a fourth inner layer adjacent to the third inner layer, the fourth inner layer comprising a second polyamide polymer;
an adhesive layer adjacent to the fourth inner layer;
a second outer layer comprising a sealing layer; and
a total composition comprising between 70% and 95%, by weight, polypropylene.

17. The multilayer barrier film of claim 16, wherein the total composition of the multilayer barrier film comprises less than or equal to 10%, by weight, EVOH copolymer, and less than or equal to 10%, by weight, polyamide polymer.

18. A retortable package comprising the multilayer barrier film claim 1.

19. The retortable package of claim 18 comprising a bottom web comprising a film that is thermoformed, and a top web comprising a film that is not thermoformed; wherein at least one of the bottom web and the top web comprise the multilayer barrier film.

20. The retortable package of claim 18 in the form of a pouch comprising one or more sidewalls formed from the multilayer barrier film.
